(19) United States
(12) Patent Application Publication
(10) Pub. No.: US 2015/0198518 A1
(43) Pub. Date: Jul. 16, 2015

(54) CATHODIC PROTECTION REFERENCE CELL ARTICLE AND METHOD

(71) Applicants: Frank William Borin, Marina Del Rey, CA (US); Beth Ellen Weaver, Los Angeles, CA (US)

(72) Inventors: Frank William Borin, Marina Del Rey, CA (US); Beth Ellen Weaver, Los Angeles, CA (US)

(21) Appl. No.: 14/157,297

(22) Filed: Jan. 16, 2014

(51) Int. Cl. G01N 17/02

(52) U.S. Cl. CPC G01N 17/02

(57) ABSTRACT

An article for enabling determination of corrosion m a structure which is located in an environment and is subject to corrosion in the environment. The article comprises a cathodic protection reference cell. The cathodic protection reference cell is able to be located in the environment at a location different from the location of the structure in the environment, and is able to be electrically coupled to the structure. The cathodic protection reference cell comprises a housing, and a reference electrode located in the housing. The reference electrode is able to be electrically connected to the structure which is located in the environment, to form a reference electrode-structure circuit. The reference electrode functions as an electrochemical cell, which enables measurement of the voltage drop which represents the structure-to-environment potential, for enabling the determination of the extent of cathodic protection of the structure.

### COPYRIGHTABLE SUBJECT MATTER

A portion of the disclosure of this patent, document contain material which is subject to copyright protection. The copyright owner has no objection, to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention is generally related to corrosion control, and more particularly, to an article and method for providing a cathodic protection reference cell for detecting corrosion in structures.

2. General Background and State of the Art

Cathodic protection is an electrochemical means of corrosion sensing and control in which the oxidation reaction in a galvanic cell is concentrated at the anode and suppresses corrosion of the cathode in the same cell

A galvanic cell is an electrochemical cell that derives electrical energy from spontaneous redox reactions, wherein one molecule is reduced and another oxidized, taking place within the cell. It generally consists of two different metals connected by a salt bridge, or individual half-cells separated by a porous membrane.

When dissimilar metals are in electrical or physical contact (the former through an electrolyte) galvanic corrosion can take place. The process is akin to a simple DC cell in which the more active metal becomes the anode and corrodes, where as the less active metal becomes the cathode and is protected. The electromotive force can be used to predict the metal which will corrode in contact with another metal, based on whether it is cathodic or anodic with respect to another.

In a simple cathodic protection system, a steel pipeline is cathodically protected by its connection to a sacrificial anode such as magnesium buried in the same soil electrolyte

Virtually all modern pipelines are coated with a protective coating that is supplemented by cathodic protection systems sized to prevent corrosion at imperfections in the protective coating. This combination of protective costing and cathodic protection is used on virtually all immersed or buried carbon steel structures.

The anode is the electrode at which a net oxidation reaction occurs, whereas cathodes are electrodes at which net reduction reactions occur. All cathodic protection systems require an anode, a cathode, an electric circuit between the anode and cathode, and an electrolyte.

Cathodic protection can be accomplished by two widely used methods, structure to metal coupling or impressing current and a structure.

By coupling a given structure (as iron) with a more active metal such as zinc or magnesium this produces a galvanic cell in which the active metal works as an anode and provides a flux of electrons to the structure, which then becomes the cathode. The cathode is protected and the anode progressively gets destroyed, and is therefor called a sacrificial anode.

The second method involves impressing a direct current between an inert anode and the structure to be protected. Since electrons How to the structure, it is protected from becoming the source of electrons, namely the anode. In impressed current systems, the anode is buried and a low voltage DC current is impressed between the anode and the cathode.

Sacrificial anode systems require only a material anodic to the protected steel in the environment of interest. In an impressed-current system used to protect a pipeline, the buried anodes and the pipeline are both connected to an electrical rectifier, which supplies direct current to the hurled electrodes (anodes and protected cathode) of the system.

Unlike sacrificial anodes, impressed-current anodes need not be naturally anodic to steel. Most impressed-current anodes are made from non-consumable electrode materials that are naturally cathodic to steel. If these electrodes were wired directly to a structure, they would act as cathodes and would cause accelerated corrosion of the structure they are intended to protect The direct current source reverses the Batumi polarity and allows the materials to act like anodes. Instead of corrosion of the anodes, some other oxidation reaction, that is, oxygen or chlorine evolution, occurs at the anodes, and the anodes are not consumed.

Impressed-current systems are more complex than sacrificial anode systems. The capital expenses necessary to supply direct current to the system are higher than for a simple connection between an anode and a cathode. The voltage differences between anode and cathode are limited in sacrificial anode systems, depending on the anode material and the specific environment. Impressed-current systems can use larger voltage differences. The larger voltages available with impressed-currents allow remote anode locations, which produce more efficient current distribution patterns along the protected cathode. These larger voltages are also useful in low-conductivity environments, such as freshwater and concrete, in which sacrificial anodes would have insufficient throwing power.

Most structures can be inspected to determine if they are protected relative to this standard. The only equipment necessary is a reference cell and a wire lead that can be connected to the structure in question. The other criteria require record keeping, the ability to interrupt current (impossible for most sacrificial anode designs), and more sophisticated survey equipment.

A reference cell electrode is an electrochemical cell for use in cathodic protection systems to provide corrosion, control through, electrolysis. In electrochemistry there are different types of electrochemical cells. An electrolytic cell is defined by four parts: an anode, a cathode, an electrolyte and a metallic path. The active metal site, the anode, loses cations into the electrolyte as its electrons flow through the metallic path towards the cathode. As an abundance of electrons are generated on the cathode two different reactions can occur. If there are any cations in the electrolyte of the cathode metal they can accept the surface electron and reattach to the cathode as pure metal. The other is hydrogen generation. In the electrolyte there are hydronium ions that in the presence of electrons can form hydrogen gas. The reference electrode in this system is making sure the above reaction is occurring and at what rate by being a measure of the voltage output.

When a reference cell is buried as a stationary reference electrode the voltage drop across the electrode represents the pipe to soil potential. A pipe to soil potential is what indicates whether or not the pipe is cathodically protected. The voltage run off from the pipe is at imperfections if the pipe is coated (or in general if not). According to standards, if this value meets qualifying standards then the pipe is cathodically protected. This establishes that the current is flowing from the anodes to the cathode (the pipe, tank, etc.) and keeping the cathode from corroding to its metal oxide.

The reference electrodes of cathodic protection reference cells are comprised of elements subject to ineffective operation or failure upon exposure to destructive elements in their environment. This may result upon exposure to the chemical composition of an environment, such as soil in which reference cells are buried. Such destructive elements include, for example, hydrocarbons, which are everywhere in the soil, particularly in urban environments. Hydrocarbons in the soil result from use as fuels, solvents, and as raw materials in dyes, pesticides and plastics, and from combustion in automobile engines and industrial plants. These hydrocarbons in the soil interact with cathodic protection reference cells buried in the soil to interfere with or prevent reference cell operations.

Therefore, there has been identified a continuing need to provide an article and method for providing cathodic protection through a reference cell to enable effective and verifiable determination of corrosion in structures in soil environments.

### INVENTION SUMMARY

Briefly, and in general terms, in accordance with aspects of the invention, and in a preferred embodiment, by way of example, there is provided an article and method for enabling determination of corrosion m structures in soil environments.

In accordance with aspects of the invention, the reference electrode of the cathodic protection reference cell is comprised of an element which is non-chemically reactive, is more thermodynamically stable, and is more universally effective than the elements of which other reference electrodes are comprised in environments such as hydrocarbon environments.

Further, in accordance with aspects of the invention, the cathodic protection reference cell verifies that a cathodic protection system which is installed is working correctly.

Also, In accordance with aspects of the invention, there is further provided a cathodic protection reference cell which enables use in environments regardless of the chemical composition of that environment.

In accordance with further aspects of the invention, the protective feature of the cathodic protection reference cell prevents impairment of operational capability in environments which include destructive elements.

In accordance with other aspects of the invention, the cathodic protection reference cell enables effective corrosion control through electrolysis.

Also, in accordance with aspects of the invention, the protective feature of the cathodic protection reference cell prevents destruction of operational capability when buried in soil which includes destructive elements.

These and other aspects and advantages of the invention will become apparent from the following detailed description and the accompanying drawings, which illustrate by way of example the features of the invention.

### BRIEF DESCRIPTION OF THE DRAWINGS

FIG. 1A is an elevational partly-sectional view of the housing section of a cathode protection reference cell, including a ceramic membrane, a reference electrode housed in the ceramic membrane, and a connecting wire connected to the reference electrode and extending through a housing and enclosed in a sheath;

FIG. 1B is cross-sectional view of the cathode protection reference cell reference electrode of FIG. 1A, comprised of palladium;

FIG. 1C is cross-sectional view of the cathode protection reference cell reference electrode of FIG. 1A, including a core comprised of silver and a coating comprised of palladium;

FIG. 2 is a an elevational view of the cathodic protection reference cell with lead connecting wires and a first and second coupon;

FIG. 3 is an elevational view of an embodiment, of the cathodic protection reference cell with lead connecting wires and a first, second, and third coupon;

FIG. 4 an elevational partly-sectional view of the cathodic protection reference cell with a housing enclosing the reference cathode-ceramic membrane of the cathodic protection reference cell;

FIG. 5 is a view of the cathodic protection reference cell and sheath-enclosed connecting lead-wires, connected to a remote monitoring box, to which is also connected a sheath-enclosed lead connecting wire connected to a pipe buried in the ground.

### DETAILED DESCRIPTION OF THE PREFERRED EMBODIMENTS

The article as shown comprises a cathodic protection reference cell, in a system for enabling operational determination of corrosion in structures in environments which include deleterious chemical compositions. It is substantially impervious to exposure to destructive elements such as hydrocarbons which are ubiquitous in urban environments, and other destructive elements such as chlorides and the like.

It verifies that a cathodic protection system which is installed is working correctly. It enables effective corrosion control through electrolysis. It can be used for cathodic protection of pipelines, tanks, reinforced concrete and metal structures, and it can be used for soil studies.

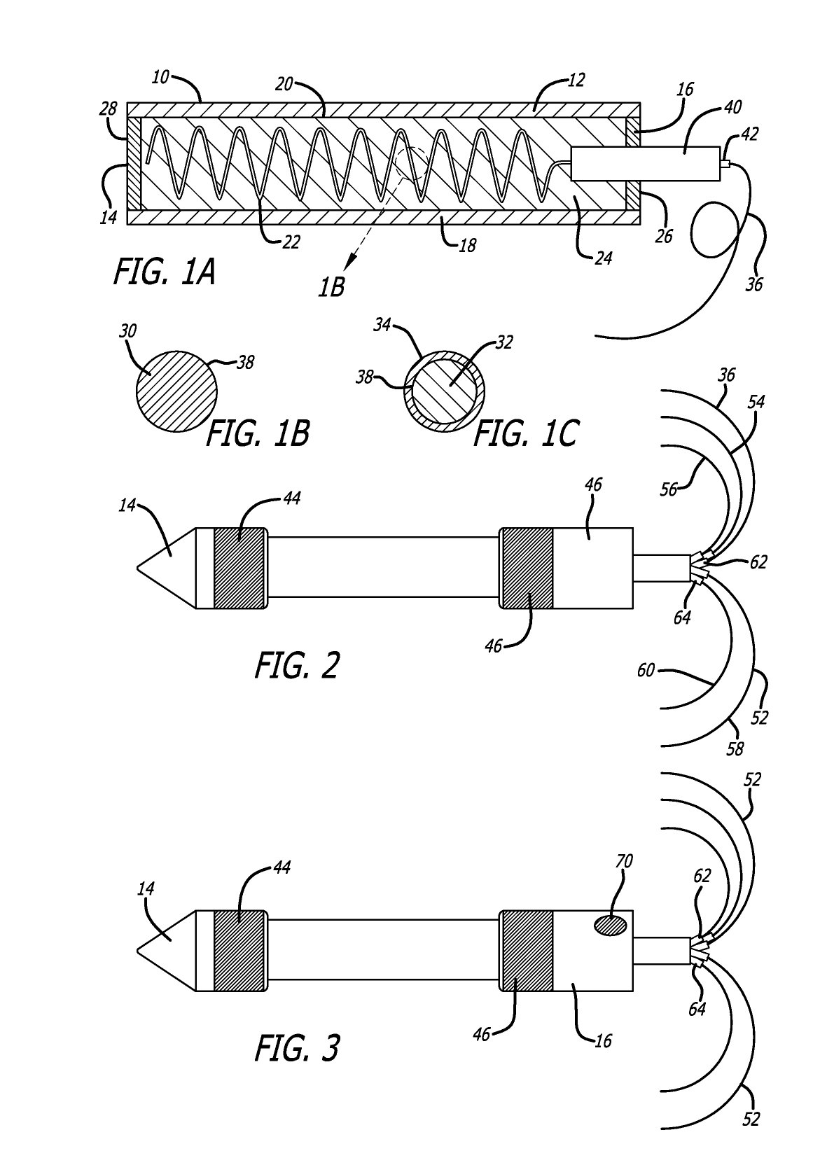

Referring to the drawings, FIGS. 1-5, in which like reference numerals refer to corresponding parts, FIG. 1A shows the cathodic protection reference cell 10 which includes a housing 12. The housing 12 includes a first, end 14, a second end 16, and a medial section 18.

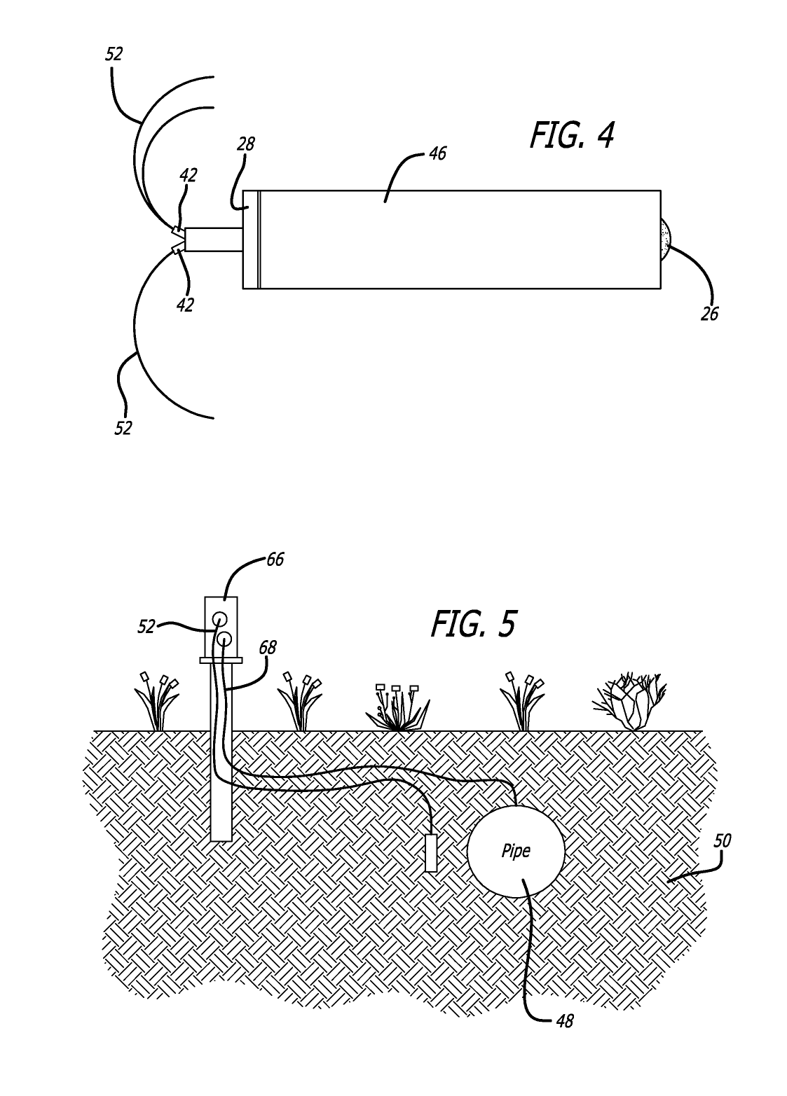

The medial section 13 of housing 12, as seen in FIG. 1A, includes a ceramic tubular membrane 20, which as shown is comprised of an alumina ceramic, and a reference electrode 22 in the ceramic tubular membrane 20. The reference electrode 22 is surrounded in the ceramic tubular membrane 20 by a mixture 24. The mixture 24 which surrounds the reference electrode 22 is comprised of sodium chloride and plaster. The housing 12 further includes a front end plug 26 and a rear end plug 28, as illustrated in FIG. 4. The rear end plug 28 in an alumina ceramic plug that contains a moisture retention membrane.

In FIGS. 1B and 1C, which are cross-sections of alternative configurations of the reference electrode 22 in FIG. 1A, the reference electrode 22 is comprised of a pure palladium rod 30, as in FIG. 1B, or consists of an inner rod 32 which is comprised of silver, surrounded by a coating 34 such as palladium as in FIG. 1C, which coating 34 is electroplated to a thickness of at least 125 μm. In the coated reference electrode, including the inner rod 32 and the coating 34 in FIG. 1C, the plating of palladium over silver also provides the same palladium chemical behavior as in the pure palladium rod 30 in FIG. 1B.

The noble, inert metal of palladium does not chemically react in situations where copper, silver or zinc might, it is more thermodynamically stable in hydrocarbon environments. If is also stable in both fresh and seawater environments. By being this stable, a palladium reference electrode 22 is the most universally effective of reference electrodes.

As seen in FIG. 1A, the reference electrode 22, which is generally 6 to 18 inches long depending on the type of reference electrode utilized, and in the embodiment shown in FIG. 1A is 12 inches long, is coiled in a loose corkscrew, shortening its length by a third to a half. A wire 36, preferably comprised of copper, is then soldered to one end of the reference electrode 22.

The reference electrode 22 is placed in an alumina ceramic tube 38 with attached ABS plastic. The ABS plastic holds coupons, which are dimensioned for example as 100 cm squares. The tube 38 is then packed with a mixture of plaster and a saturated ion solution of sodium chloride, potassium chloride, silver chloride or palladium II chloride which are poured in surrounding the reference electrode 22. The tube 38 is then sealed with the soldered wire 36 attached at one end.

A tubular housing 40 extends through the rear end plug 28 of the medial section 18 of the reference cell 10. A sheath 42, protectively enclosing soldered wire 36, is connected to, and extends from, the reference electrode 22 through the tubular housing 40 mounted in the rear end plug 28.

In FIG. 2, the first end 14 of the reference cell 10 includes a first coupon 44, and the second end 16 includes a second coupon 46.

The coupons 44 and 46, as seen in FIG. 2, are pieces of metal. Each coupon is identical in chemical composition to the makeup of the tank, pipe, or whatever structure is being protected.

When readings are taken on a structure such as pipe 48 buried in the ground 50, as seen in FIG. 5, the readings would be taken with an “on” potential and then an instant “off”. Since there is always a potential running down a pipe 48, a reading is taken when the potential is “on”, then it is turned “off” and another reading is taken, and the comparison of the readings reflects whether or not there is cathodic protection on the pipe 48.

The coupons 44 and 46, shown in FIG. 2, mimic the pipe 48, so that instead of turning off current on the pipe 48, which is difficult, expensive, and time-consuming, the coupons 44 and 46, of the same chemical composition as the pipe 48, mimic the pipe's behavior, but are much smaller and easier to torn “off” and “on”.

There are multiple coupons 44 and 46 on the reference cell 10 because one is able to freely corrode and the other is protected exactly the same as the pipe 48. This provides a comparison of what the potential would be on a freely corroding coupon 44 and 48 just as if there was something not protected and buried in the ground 50, as compared to what the potential is on the pipe 48 that is protected.

FIG. 2 shows connecting wires 52, which include the reference cell lead wire 36, a dead lead wire 54 from the first coupon 20, a live lead wire 56 from the first coupon 44, a live lead wire 58 from the second coupon 46, and a dead lead wire 60 from the second coupon 22. Sheaths 62 and 64 enclose wires 50, 52, 54, 56 58, and 60.

As seen in FIG. 4, upon installation of the system, the reference cell 10 and the pipe 48 are buried in the ground 50. The wires 36, 52, 54, 56 58, and 60 in the sheaths 62 and 64, which extend from the reference cell 10, are connected at the opposite end to a remote monitoring connection box 66, as is a connecting wire 68 in a sheath, which is connected at the opposite end to the pipe 48. The connecting wires, including 36, 52, 54, 56 58, and 60 from the reference cell 10 which are enclosed in sheaths 62 and 64, and the connecting wire 68 from the pipe 48 which is enclosed in a sheath, are connected in the remote monitoring connection box 66, tor enabling remote monitoring of corrosion in the pipe 48.

In an embodiment of the invention, as seen in FIG. 3, a three coupon system includes the first coupon 44, the second coupon 46, and a third coupon 68. The second coupon 46 and the third coupon 68 measure stray ac current that can be on the pipe 48. The ac current on the pipe 48 reflects the cathodic protection. The electrical system for the reference cell 10 is all ac current. Stray ac current can affect corrosion. It is desirable to know if stray ac current is present, because it is hard to detect, people can get hurt by it, and it can be causing corrosion. Stray ac current will run down from ac sources, and will run off as extra electricity into the ground 50, and the extra electricity can travel through the ground 50 and onto the pipe 48. The second coupon 46 and the third coupon 68 function to measure stray ac current that can be on the pipe 48, to detect resulting corrosion on the pipe 48.

In operation, the cathodic protection reference cell 10 functions as an electrochemical cell. In electrochemistry there are different types of electrochemical cells. An electrolytic cell is defined by four parts, an anode, a cathode, an electrolyte and a metallic pads. The active metal site, the anode, loses cations into the electrolyte as its electrons flow through the metallic path towards the cathode.

As there is an abundance of electrons on the cathode, two different reactions can occur. If there are any canons in the electrolyte of the cathode metal they can accept the surface electron and reattach to the cathode as pure metal. The other reaction is hydrogen, generation. In the electrolyte there are hydronium ions that in the presence of electrons can form hydrogen gas.

The reference electrode 22 operates in the system to insure that the reactions are occurring and at what rate, by being a measure of the voltage output.

The process of installation of a reference cell 10 includes pre-soaking and soaking on site in water for a period of time, such as twenty seconds. The reference cell 10 uses water to enable an ion flow, in order to have ions that can move back and forth through the ceramic membrane 20, which provides the potential.

When the reference cell 10 is buried as a stationary reference electrode 22, the voltage drop across the reference electrode 22 represents the pipe 48 to ground 50 potential. A pipe 48 to ground 50 potential is what determines whether or not the object being protected, such as pipe 48, is cathodically protected.

The voltage run off from the pipe at holidays, which are imperfections such as corrosion in the pipe 48, is determined by the pipe 48 to ground 50 potential sensed by the reference cell 10. According to standards, if this value meets qualifying standards of voltage shift, then the pipe 48 is cathodically protected. The voltage shift, if within the standard range, shows that the current is flowing from the anodes to the cathode, that the cathode is protected from corroding to its metal oxide, and that the pipe 48 is cathodically protected.

While the particular cathodic protection reference cell as shown and disclosed in detail herein is fully capable of obtaining the objects and providing the advantages previously stated, it is to be understood that it is merely illustrative of the presently preferred embodiment of the invention, and that no limitations are intended to the details of construction or design shown herein other than as described in the appended claims.

We claim:

1. An article for enabling determination of corrosion, in a structure which is located in an environment and is subject to corrosion in the environment, which article comprises a cathodic protection reference cell, wherein the cathodic protection reference cell is able to be located in the environment at a location different from the location of the structure in the environment, and is able to be electrically coupled to the structure for enabling detection of corrosion in the structure by the cathodic protection reference cell, and wherein the cathodic protection reference cell comprises:
a housing; and
a reference electrode, located in the housing, able to be electrically connected to the structure which is located in the environment to form a reference electrode-structure circuit, wherein the reference electrode enables determination of corrosion in the structure in the environment, and functions as an electrochemical cell which enables measurement of the voltage drop across the cathodic protection reference electrode, which voltage drop represents the structure-to-environment potential for enabling the determination of the extent of cathodic protection of the structure.

2. An article as in claim 1, wherein the reference electrode is comprised of a material which enhances stability and inhibits chemical reaction of the reference electrode in the environment

3. An article as in claim 1, wherein the reference electrode is comprised of palladium.

4. An article as in claim 1, wherein the reference electrode includes an inner section and a coating extending about the inner section, and wherein the coating is comprised of palladium.

5. An article as in claim 1, wherein the reference electrode-structure circuit includes an anode, a cathode, an electrolyte and a metallic path.

6. An article as in claim 1, further comprising a membrane, and wherein the reference electrode is enclosed in the membrane, and there is a space between the membrane and the reference electrode.

7. An article as in claim 4, wherein the inner section is comprised of silver.

8. An article as in claim 5, wherein the anode in the reference electrode-structure circuit structure comprises the structure.

9. An article as in claim 5, wherein the cathode in the reference electrode-structure circuit structure comprises the reference electrode.

10. An article as in claim 5, further comprising a liquid in which the reference electrode is soaked, and wherein the electrolyte in the reference electrode-structure circuit comprises the liquid in which the reference electrode is soaked.

11. An article as in claim 5, further comprising wires electrically connecting the structure to the reference electrode, and wherein the electrolyte in the reference electrode-structure circuit comprises the wires electrically connecting the structure to the reference electrode.

12. An article as in claim 6, wherein the reference cell includes a liquid soaked in the reference cell to enable ion flow through the membrane to generate the structure-to-environment potential.

13. An article as in claim 6, wherein the space between the reference electrode and the membrane is filled with a mixture.

14. An article as in claim 8, wherein the structure anode in the reference electrode-structure circuit loses cations into the electrolyte as its electrons flow through the reference electrode-structure circuit metallic path towards the cathode.

15. An article as in claim 13, wherein the mixture is comprised of sodium chloride and plaster.

16. A method of enabling determination of corrosion in a structure which is located in an environment and is subject to corrosion in the environment, in an article which comprises a cathodic protection reference cell which comprises a housing, and a reference electrode, located in the housing, able to be electrically connected to the structure which is located in the environment to form a reference electrode-structure circuit, wherein the reference electrode enables determination of corrosion in the structure in the environment, and functions as an electrochemical, cell which enables measurement of the voltage drop across the cathodic protection reference electrode, which voltage drop represents the structure-to-environment potential for enabling the determination of the extent of cathodic protection of the structure, wherein the method comprises:
locating the cathodic protection reference cell in the environment at a location different from the location of the structure in the environment; and
electrically coupling the cathodic protection reference cell to the structure for enabling detection of corrosion in the structure by the cathodic protection reference cell.

17. A method as in claim 16, wherein the reference electrode is composed of a material which enhances stability and inhibits chemical reaction of the reference electrode in the environment, and wherein the method of electrically coupling further comprises enhancing stability and inhibiting chemical reaction by the reference electrode.

18. A method as in claim 16, wherein the reference electrode is comprised of palladium, and wherein the method of electrically coupling further comprises electrically coupling the palladium reference electrode.

19. A method as in claim 16, wherein the reference electrode includes an inner section and a coating extending about the inner section, and the coating is comprised of palladium, and wherein the method of electrically coupling further comprises electrically coupling the inner section and the palladium coating of the reference electrode.

20. A method as in claim 16, wherein the reference electrode-structure circuit includes an anode, a cathode, an electrolyte and a metallic path, and wherein the method of electrically coupling further comprises electrically coupling the reference electrode-structure circuit through the anode, the cathode, the electrolyte and the metallic path.
